(19) United States
(12) Patent Application Publication
(10) Pub. No.: US 2008/0032050 A1
(43) Pub. Date: Feb. 7, 2008

(54) METHOD OF PRODUCING PATTERNED ARTIFICIAL MARBLE

(75) Inventor: Jung Soo Yoon, Incheon (KR)

Correspondence Address: SCHMEISER OLSEN & WATTS, 18 E UNIVERSITY DRIVE, SUITE # 101, MESA, AZ, 85201, US

(73) Assignee: GEESAN M-TECK CO., LTD., Incheon (KR)

(21) Appl. No.: 11/772,722

(22) Filed: Jul. 2, 2007

(30) Foreign Application Priority Data
Aug. 4, 2006 (KR) 10-2006-0073572

(51) Int. Cl. B05D 3/02

(52) U.S. Cl. 427/385.5

(57) ABSTRACT

Disclosed is a method of producing patterned artificial marble, including applying a main slurry for acrylic artificial marble having a single color or a mixed color through a fixed main nozzle to a predetermined thickness on a film being conveyed at a predetermined speed; lowering a patterning nozzle, which is mounted above the film being conveyed so as to be intermittently vertically movable, to the bottom of the main slurry applied on the film conveyed below the patterning nozzle, and then raising it while injecting a patterning slurry having a color different from that of the main slurry into the main slurry to create a desired pattern; and curing the patterned artificial marble slurry having a predetermined thickness in which the patterning slurry is injected into the main slurry to create a desired pattern, and then conducting cutting to a predetermined size and sanding, thus obtaining patterned artificial marble. The patterned artificial marble can exhibit patterns having various sizes and colors, which have not been shown in conventional artificial marble, and thus, realizes superior interior appearances, remarkably improving users' interest in the products and product reliability.

### BACKGROUND OF THE INVENTION

1. Field of the Invention

The present invention relates to a method of producing patterned artificial marble, and, more particularly, to a method of producing patterned artificial marble having various colors and patterns, by injecting a patterning slurry, having desired colors and patterns, into a main slurry, through one or more patterning nozzles which are vertically movable.

2. Description of the Related Art

In recent years, artificial marble has been primarily used for interior decoration in buildings. Such artificial marble is classified into unsaturated polyester-based artificial marble and acrylic artificial marble, depending on the type of base resin.

The unsaturated polyester-based artificial marble, having easy formability, is mainly commercialized into molded products, for example, bathtubs and washbowls, but the use thereof is limited due to the poor processability thereof.

On the other hand, acrylic artificial marble exhibits a beautiful color tone and a graceful texture thanks to the transparency of the resin, and furthermore, has superior processability because it may be subjected to machining using woodworking machines, and thus it is widely used in the interior design field. Such acrylic artificial marble is prepared by mixing an acrylic resin syrup with an inorganic filler, a crosslinking agent, and a polymerization initiator to thus prepare a monochromatic artificial marble slurry, adding a pigment thereto with stirring to obtain a marble plate, which is then crushed into marble chips having a size of 0.1˜10 mm, and mixing a predetermined amount of the marble chips, thereby producing acrylic artificial marble having a granite pattern.

In addition, in the conventional process for patterning the acrylic artificial marble, the artificial marble slurry is added with a pigment for imparting a flow pattern to thus obtain a realistic flow of artificial marble slurry, or to thus obtain a Bianco pattern, a woodgrain pattern, or a wave pattern using a comb-like tool.

However, the conventional method of producing the patterned artificial marble suffers, because the shape and size of the pattern cannot be set as desired, and therefore it is difficult to realize the diversification of products, undesirably decreasing users' interest in the products.

### SUMMARY OF THE INVENTION

Accordingly, the present invention has been made keeping in mind the above problems occurring in the prior art, and an object of the present invention is to provide a method of producing patterned artificial marble, which is capable of manifesting patterns having various sizes and colors.

In order to accomplish the above object, the present invention provides a method of producing patterned artificial marble, including injecting a patterning slurry into a main slurry, sprayed onto a form from a main nozzle, through one or more patterning nozzles which are vertically movable, and curing it, thereby obtaining patterned artificial marble exhibiting desired colors and patterns. Specifically, the present invention provides a method of producing patterned artificial marble, including applying a main slurry for acrylic artificial marble having a single color or a mixed color to a predetermined thickness onto a film being conveyed at a predetermined speed, through a fixed main nozzle; lowering a patterning nozzle, which is mounted above the film being conveyed so as to be intermittently vertically movable, to the bottom of the main slurry that has been applied on the film conveyed below the patterning nozzle, and then raising it while injecting a patterning slurry having a color different from that of the main slurry into the main slurry to impart a predetermined pattern; and curing the patterned artificial marble slurry having a predetermined thickness, in which the patterning slurry is injected into the main slurry to create a predetermined pattern, and then conducting cutting to a predetermined size and sanding, thus obtaining patterned artificial marble.

### BRIEF DESCRIPTION OF THE DRAWINGS

FIG. 1 illustrates the apparatus for realizing the process of producing patterned artificial marble according to the present invention;

FIG. 2A illustrates the discharge of the main slurry in the process of producing the patterned artificial marble according to the present invention;

FIG. 2B illustrates the waiting for the discharge of the patterning slurry in the process of producing the patterned artificial marble according to the present invention; and

FIG. 2C illustrates the completion of the discharge of the patterning slurry in the process of producing the patterned artificial marble according to the present invention.

### DESCRIPTION OF THE PREFERRED EMBODIMENT

Hereinafter, a detailed description will be given of the preferred embodiment of the present invention with reference to the accompanying drawings.

First, a known method of preparing an acrylic artificial marble slurry, including mixing an acrylic resin syrup with an inorganic filler, a crosslinking agent, and a polymerization initiator with stirring, is briefly described below.

The acrylic resin syrup is a syrup in which an acrylic monomer and a polymer thereof, for example, polyacrylate, are dissolved. Examples of the acrylic monomer include methyl methacrylate, methacrylic acid, and isopropyl methacrylate.

The acrylic resin syrup used in the present invention includes 65 wt % or more of the acrylic monomer and 35 wt % or less of the acrylic polymer.

The inorganic filler may be selected from among various powdered materials that are harmless to the human body, including aluminum hydroxide, silica, calcium carbonate, gemstone powder, and yellow clay powder, and is used in an amount of 50˜250 parts by weight based on 100 parts by weight of the acrylic resin syrup.

Examples of the crosslinking agent include polyfunctional methacrylates, such as ethyleneglycol dimethacrylate, propyleneglycol dimethacrylate, glycerol trimethacrylate, and bisphenol A dimethacrylate. The polyfunctional monomer may be used in an amount of 0.1˜0.2 parts by weight, and preferably 0.1˜0.5 parts by weight, based on 100 parts by weight of the acrylic resin syrup.

The polymerization initiator is exemplified by peroxides, such as benzoyl peroxide, lauroyl peroxide, butyl hydroperoxide, and cumyl hydroperoxide, or azo compounds, such as azobis isobutyronitrile, and is used in an amount of 0.1˜10 parts by weight based on 100 parts by weight of the acrylic resin syrup.

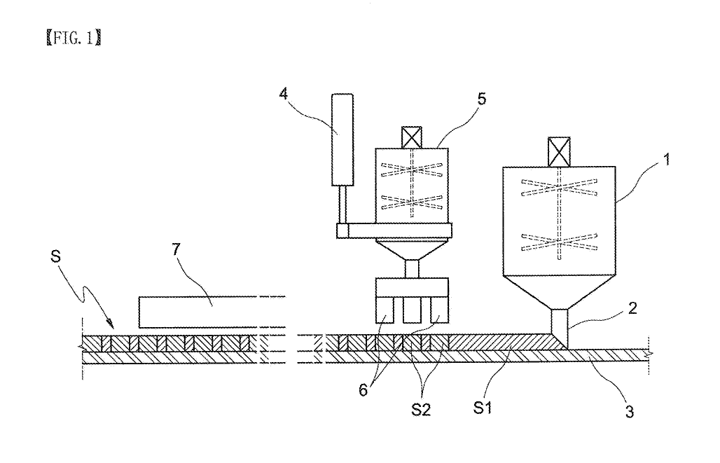

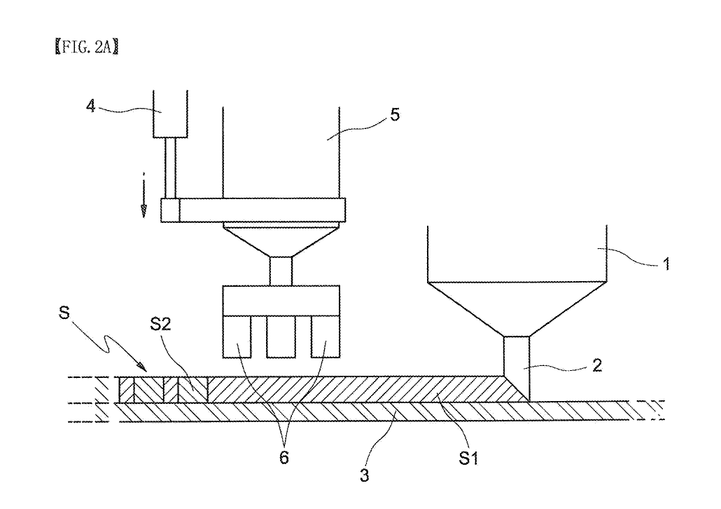

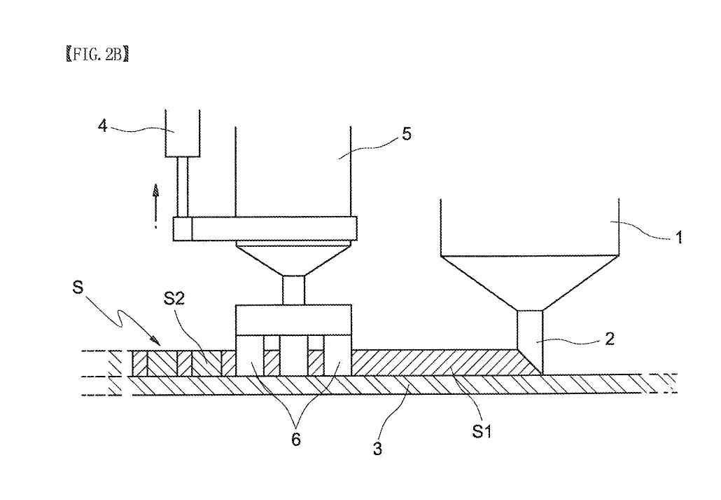

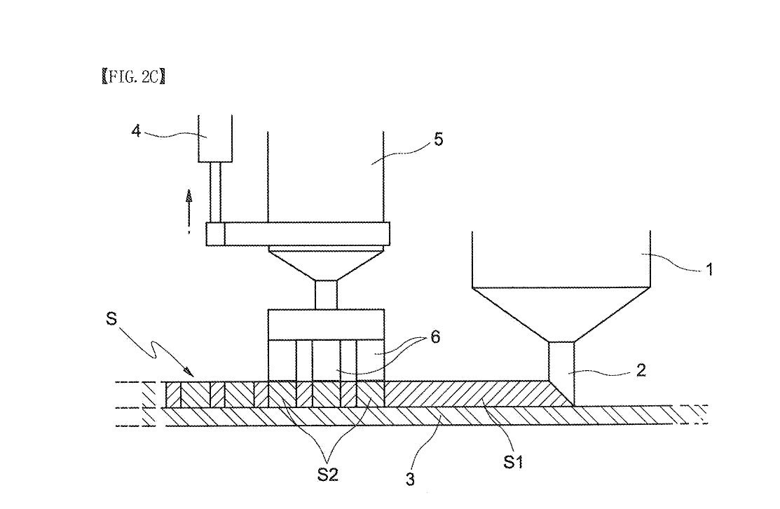

FIG. 1 illustrates the apparatus for realizing the process of producing the patterned artificial marble according to the present invention, and FIGS. 2A, 2B, and 2C sequentially illustrate the process of the present invention.

The apparatus for producing the patterned artificial marble is described with reference to the method of producing the patterned artificial marble according to the present invention.

Discharge of Main Slurry

A main slurry S1 is discharged from a main nozzle 2 of a fixed main mixing tank 1. Under the main nozzle 2, a film 3 performing conveyance at a predetermined speed to the left side from the right side in the drawing, is provided so that the main slurry S1 discharged from the main nozzle 2 is applied to an appropriate thickness thereon, as shown in FIG. 2A.

The film 3 is provided on a conveyor, on which the entire process of the present invention is conducted, but which is not shown in the drawing. Thus, the film material, which may be curved along the curve of the conveyor, is used. A PVA film or a polyacetal film having a predetermined thickness may be selectively applied.

Discharge of Patterning slurry

A patterning slurry S2 is ejected from patterning nozzles 6 under a pattern mixing tank 5, which is mounted so that it is vertically movable by a cylinder 4 at the side of the main mixing tank 1, that is, above the film 3 being conveyed. As shown in FIG. 2A, when the main slurry S1 applied on the film 3 is conveyed below the patterning nozzles 6, the cylinder 4 extends so that the pattern mixing tank 5 having the patterning nozzles 6 descends.

Subsequently, as shown in FIG. 2B, the patterning nozzles 6 are lowered to the bottom of the main slurry S1, and are then raised while injecting the patterning slurry S2 into the main slurry S1. At this time, the patterning slurry S2 may be injected to have various shapes and sizes depending on the types of the patterning nozzles 6.

The number of patterning nozzles 6 may be one or more, in some cases, tens or hundreds, depending on the sizes, intervals, and colors of patterns. The patterning slurry S2 injected into the main slurry S1 may be arranged to have various sizes and colors.

Here, the amount of the discharged main slurry S1 is set such that the main slurry is not thicker than the actual thickness of the patterned artificial marble, in consideration of the speed at which the film 3 is conveyed. Furthermore, the discharge of the patterning slurry S2 is intermittently controlled depending on the diameter of the patterning nozzle 6 and the speed at which the film 3 is conveyed.

Also, it is natural that the amounts of the main slurry S1 and the patterning slurry S2 injected thereinto be controlled to be equal to the desired thickness of the patterned artificial marble.

Completion

A patterned artificial marble slurry S, in which the patterning slurry S2 is injected into the main slurry S1, is slowly cured in an oven 7 at 50° C. for 1 hour, thus obtaining a patterned artificial marble plate. Subsequently, the patterned artificial marble plate is cut to a necessary size, and the surfaces and edges thereof are subjected to sanding, thereby completing the patterned artificial marble.

As described above, the present invention provides a method of producing patterned artificial marble. According to the method of the present invention, the patterned artificial marble may exhibit patterns having various sizes and colors, which have not been shown in conventional artificial marble, and thus may realize superior interior appearances, remarkably improving user's interest in the products and product reliability.

What is claimed is:

1. A method of producing patterned artificial marble comprising:
applying a main slurry for acrylic artificial marble having a single color or a mixed color through a fixed main nozzle to a predetermined thickness on a film being conveyed at a predetermined speed;
lowering a patterning nozzle, which is mounted above the film being conveyed so as to be intermittently vertically movable, to a bottom of the main slurry applied on the film conveyed below the patterning nozzle, and then raising it while injecting a patterning slurry having a color different from that of the main slurry into the main slurry to create a predetermined pattern; and
curing the patterned artificial marble slurry having a predetermined thickness, in which the patterning slurry is injected into the main slurry to create a predetermined pattern, and then conducting cutting to a predetermined size and sanding, thus obtaining patterned artificial marble.
